(19) United States
(12) Patent Application Publication
(10) Pub. No.: US 2013/0209017 A1
(43) Pub. Date: Aug. 15, 2013

(54) ARMATURE SHAFT BEARING UNIT

(71) Applicants: Joachim Schadow, Stuttgart (DE); Sinisa Andrasic, Schoenaich (DE); Marcus Schuller, Dettenhausen (DE)

(72) Inventors: Joachim Schadow, Stuttgart (DE); Sinisa Andrasic, Schoenaich (DE); Marcus Schuller, Dettenhausen (DE)

(73) Assignee: Robert Bosch GmbH, Stuttgart (DE)

(21) Appl. No.: 13/701,404

(22) PCT Filed: Apr. 27, 2011
(86) PCT No.: PCT/EP2011/056612

§ 371 Date: Feb. 18, 2013

(30) Foreign Application Priority Data
Jun. 24, 2010 (DE) 102010030494.8

(51) Int. Cl. F16F 15/12; F16C 33/30

(52) U.S. Cl. CPC F16F 15/1201; F16C 33/30
USPC 384/536; 267/141

(57) ABSTRACT

An armature shaft bearing unit, particularly for an angle grinding machine, includes at least one damping element configured to damp vibrations of an armature shaft. The armature shaft bearing unit further includes at least one movement limiting element configured to limit a movement of the armature shaft in at least one damping direction of the at least one damping element.

### PRIOR ART

Armature shaft bearing units for portable power tools, comprising a damping element for damping vibrations of an armature shaft, are already known.

### DISCLOSURE OF THE INVENTION

The invention is based on an armature shaft bearing unit for a portable power tool, in particular for an angle grinder, comprising at least one damping element which is designed to damp vibrations of an armature shaft.

It is proposed that the armature shaft bearing unit has at least one motion limiting element, which is designed to limit a motion of the armature shaft in at least one damping direction of the at least one damping element. By an “armature shaft bearing unit” should here be understood, in particular, a bearing unit for the armature shaft, which bearing unit rotatably supports the armature shaft in a housing of a portable power tool. Preferably, the armature shaft bearing unit, in a mounted state of the armature shaft in a housing of a portable power tool, in particular an angle grinder, is disposed on a side of the armature shaft which is facing away from the gear mechanism of the portable power tool and supports the armature shaft on the side facing away from the gear mechanism and is thus preferably formed by a rear armature shaft bearing unit. An arrangement of the armature shaft bearing unit on a side of the armature shaft, in a mounted state, which is facing toward the gear mechanism is likewise conceivable. Furthermore, an arrangement of two substantially analogously configured armature shaft bearing units on that side of the armature shaft which is facing toward the gear mechanism and on that side of the armature shaft which is facing away from the gear mechanism is likewise conceivable. By a “damping element” should here be understood, in particular, a component which is specifically designed to convert vibrations, in particular vibrations of the armature shaft, in the form of a kinetic energy, into thermal energy, and thus to reduce a vibration transmission, of a vibration generated by the armature shaft, via a bearing element, in particular a roller bearing, to a machine housing, in particular compared to a vibration transmission of a bearing element which is disposed directly in the housing, decoupled from a damping element. The damping element preferably has a modulus of elasticity which is less than 500 N/mm², preferably less than 100 N/mm², and particularly preferably less than 50 N/mm². The damping element is specifically designed to convert vibrations generated by the armature shaft and resulting from constantly supplied energy, in particular from a kinetic energy of the armature shaft, into thermal energy. In this context, by “designed” should be understood, in particular, specially equipped and/or specially arranged and/or specially programmed. By a “motion limiting element” should here be understood, in particular, a component configured as a mechanical stop, in particular as a mechanical stop of a bearing element, by means of which the armature shaft is rotatably supported. In particular, the motion limiting element has a modulus of elasticity which is greater than 100 N/mm², and particularly preferably greater than 500 N/mm². Preferably, the motion limiting element is formed from a different material than the damping element. It is also conceivable, however, that the damping element itself serves as a stop, in particular if the damping element is configured as a helical spring, in that a maximal compression of the damping element, such as, for instance, when a helical spring is fully pressed together, effects a limitation of the motion.

The term “damping direction” should here define, in particular, a direction in which vibrations are advantageously damped, preferably by means of the damping element. Preferably, the damping direction runs substantially perpendicular to the rotational axis of the armature shaft. The damping element can be configured as a spring element, such as, for instance, as a leaf spring, spiral spring, cup spring, wire spring, etc., or from a knitted fabric of metal and/or plastic, or as an active damping element, such as, for instance, as a piezo element or as an electrorheological or magnetorheological fluid. By an “active damping element” should here be understood, in particular, a component, which is specifically designed to damp a vibration by means of an initiation of a counter vibration. A combination of the damping element with an additional mass damper or a configuration of the damping element as a mass damper is likewise conceivable.

Furthermore, the damping element can be formed from a thermoplastic and/or from a thermoplastic elastomer (TPE) and/or from an elastomer and/or from a thermosetting plastic and/or from a metal and/or from a plastic or another material which appears sensible to a person skilled in the art. The damping element, in a configuration consisting of a thermoplastic and/or a thermoplastic elastomer (TPE) and/or an elastomer and/or a thermosetting plastic, preferably has a modulus of elasticity which is less than 500 N/mm², preferably less than 100 N/mm², and particularly preferably less than 50 N/mm². If the damping element is formed from elastomer, a Shore hardness of the damping element can advantageously be specifically adapted to a certain working method of the damping element in a mounted state. Furthermore, if the damping element is formed from a thermoplastic or another material which appears sensible to a person skilled in the art, the damping element, by means of a specific shaping, can advantageously be adapted in a mounted state to a defined working method.

For the damping of vibrations, the damping element can have, in addition to the specific shaping and the specific material selection, at least one interior space, which is filled by means of a medium, such as, for instance, with silicone and/or with gel and/or with gas and/or with grease and/or with oil and/or with dross and/or with another medium which appears sensible to the person skilled in the art. If the damping element is configured with at least one interior space, a damping behavior of the damping element can advantageously be influenced, preferably by means of a change in pressure in the interior space of the damping element and/or by means of a change in magnetic field in the case of a magnetorheological damping element. Such an adaptation of the damping element can advantageously be realized dynamically, so that, during operation of the armature shaft, the damping element can be specifically adjusted to a vibration prevailing during operation of the armature shaft. Vibrations at the armature shaft can cause a bearing outer ring of a bearing element, in particular of a roller bearing, to damage a contact surface of a bearing seat in the housing as a result of, for instance, mechanically high-frequency load fluctuations.

By means of the inventive design of the armature shaft bearing unit, such damage of this type can advantageously be prevented by means of the damping element and a high maintenance interval can advantageously be achieved. Vibrations arising as a result of, for instance, an imbalance of the armature shaft can advantageously be damped to a predetermined level and, in addition, reliable functioning of the armature shaft can be ensured by means of the motion limiting element in the event of a high amplitude of vibrations.

In addition it is proposed that the at least one damping element is at least substantially designed to damp vibrations of the armature shaft during operation in a direction at least substantially perpendicular to a rotational axis of the armature shaft. By “at least substantially designed to” should here be understood, in particular, a special arrangement of a component to fulfill a primary function of the component, wherein a geometry, a material and further parameters of the component which appear sensible to the person skilled in the art are arranged specifically to fulfill the primary function. The term “substantially perpendicular” is here meant to define, in particular, an orientation of a direction relative to a reference direction, wherein the direction and the reference direction form an angle of 90° and the angle has a maximum deviation of, in particular, less than 8°, advantageously less than 5°, and particularly advantageously less than 2°. It is also conceivable, however, that the damping element, in addition to the damping of vibrations of the armature shaft in the direction perpendicular to the rotational axis of the armature shaft, damps vibrations of the armature shaft during operation in a direction along an axial extent of the armature shaft. By a “rotational axis” should here be understood, in particular, an axis of the armature shaft about which the armature shaft, during operation, is rotatably mounted. By means of the inventive design of the armature shaft bearing unit, vibrations of the armature shaft which impact upon an operator can be damped particularly advantageously via the housing. Particularly advantageously, high ease of operation can be achieved.

It is further proposed that the armature shaft bearing unit comprises at least two damping elements, which are arranged one behind the other in a peripheral direction. By a “peripheral direction” should here be understood, in particular, a direction which runs around the armature shaft in a plane perpendicular to the rotational direction of the armature shaft. Particularly preferably, the at least two damping elements are arranged distributed evenly, in particularly symmetrically, along the peripheral direction. A specific arrangement of the damping elements onto a particularly vibration-intensive direction of a machine component, in particular the armature shaft, can advantageously be achieved.

In addition it is proposed that the armature shaft bearing unit has at least one bearing element and at least one bearing receiving element, which latter is disposed in at least one damping direction between the bearing element and the damping element. By a “bearing receiving element” should here be understood, in particular, a component in which at least one bearing element is arranged in a mounted state and which transmits forces radiating from the bearing element, in particular radial forces, in the direction of the housing, so that a force flow from the armature shaft to the bearing element via the bearing receiving element can take place directly, or, in particular, indirectly via the damping element, into the housing. The bearing element is preferably configured as a roller bearing. By means of the inventive design, the armature shaft bearing unit can advantageously be configured as a premounted assembly, so that time and assembly effort can advantageously be saved. Furthermore, a pre-existing portable power tool can be equipped in a constructively simple manner with the inventive armature shaft bearing unit.

Advantageously, the at least one motion limiting element is configured integrally with the bearing receiving element. In addition it is proposed that the bearing receiving element is configured integrally with the at least one damping element. By “configured integrally” should here be understood, in particular, a configuration of components from a single mold and/or by means of an adhesive joint and/or a weld joint and/or a multicomponent injection molding process and/or other measures which appear sensible to the person skilled in the art. Costs and installation space can advantageously be saved.

It is additionally proposed that the armature shaft bearing unit has at least two damping elements and at least one connecting element, which latter fixedly connects the two damping elements to form an assembly unit which is designed to be fitted into a portable power tool. In this context, by an “assembly unit” should be understood a unit which is mounted in place already prior to a final assembly of the armature shaft bearing unit as a functional assembly. The connecting element can be configured, for instance, as a web and/or as a ring, which captively connects the two damping elements one to the other, so that the two damping elements substantially maintain a position relative to each other. A connection of the damping elements and of the connecting element can be realized by means of a force closure method and/or preferably by means of a form closure method and/or a material bonding method. A simple assembly can advantageously be achieved, in particular where there is a plurality of damping elements to be fitted.

Preferably, the armature shaft bearing unit comprises at least two damping elements, which are spaced apart in the axial direction. By an “axial direction” should here be understood, in particular, a direction which runs at least substantially parallel to the rotational axis of the armature shaft. The damping elements are here disposed at least partially, and preferably fully, in different damping planes running perpendicular to the rotational axis of the armature shaft, wherein preferably at least two damping planes have in the axial direction a distance apart which is greater than an extent in the axial direction of at least one of the damping elements. A large damping surface for the vibration damping can hereby advantageously be achieved, so that each individual damping element is exposed to a low load.

The invention is further based on a portable power tool, in particular an angle grinder, comprising an armature shaft unit. By means of the inventive design of the portable power tool, high ease of operation for an operator of the portable power tool can be particularly advantageously achieved. The portable power tool comprises two armature shaft bearing units, which have a substantially analogous construction. One of the two armature shaft units is disposed, in a mounted state for supporting an armature shaft of the portable power tool, on a side of the armature shaft which is facing toward a gear mechanism of the portable power tool. The other of the two armature shaft bearing units is disposed on a side of the armature shaft which is facing away from the gear mechanism. Components of the portable power tool can advantageously be preserved, so that a high maintenance interval can be achieved. Vibrations arising as a result of, for instance, an imbalance of the armature shaft can advantageously be damped to a predetermined level and, in addition, reliable functioning of the armature shaft can be ensured by means of the motion limiting element in the event of a high amplitude of vibrations.

### DRAWING

Further advantages emerge from the following drawing description. In the drawing, illustrative embodiments of the invention are represented. The drawing, the description and the claims contain numerous features in combination. The person skilled in the art will expediently view the features also individually and combine them into sensible further combinations.

In the drawing:

FIG. 1 shows an inventive portable power tool in a schematic representation,

FIG. 2 shows in a schematic representation a detailed view of a first illustrative embodiment of an inventive armature shaft bearing unit, disposed in a housing unit of the portable power tool, having a bearing receiving element,

FIG. 3 shows in a schematic representation a detailed view of an alternative illustrative embodiment of an inventive armature shaft bearing unit having an alternative arrangement of damping elements in a housing,

FIG. 4 shows in a schematic representation a detailed view of a further alternative illustrative embodiment of an inventive armature shaft bearing unit having an alternative arrangement of damping elements,

FIG. 5 shows in a schematic representation a detailed view of a further alternative illustrative embodiment of an inventive armature shaft bearing unit having an alternative arrangement of damping elements in a bearing receiving element,

FIG. 6 shows in a schematic representation a detailed view of a further alternative illustrative embodiment of an inventive armature shaft bearing unit having alternative damping elements connected by means of connecting elements,

FIG. 7 shows in a schematic representation a detailed view of a further alternative illustrative embodiment of an inventive armature shaft bearing unit having receiving regions, disposed in a housing, for damping elements,

FIG. 8 shows in a schematic representation a sectional view of the inventive armature shaft bearing unit along a line VIII-VIII from FIG. 7,

FIG. 9 shows in a schematic representation a sectional view of a further alternative illustrative embodiment of an inventive armature shaft bearing unit having an alternative bearing receiving element, with an analogous section according to the line VIII-VIII,

FIG. 10 shows in a schematic representation a sectional view of a further alternative illustrative embodiment of an inventive armature shaft bearing unit having two damping planes, with an analogous section according to the line VIII-VIII,

FIG. 11 shows in a schematic representation a detailed view of a further alternative illustrative embodiment of an inventive armature shaft bearing unit having alternative damping elements,

FIG. 12 shows in a schematic representation a detailed view of a further alternative illustrative embodiment of an inventive armature shaft bearing unit having alternative damping elements,

FIG. 13 shows in a schematic representation a detailed view of a further alternative illustrative embodiment of an inventive armature shaft bearing unit having alternative damping elements, and

FIG. 14 shows in a schematic representation a detailed view of a further alternative illustrative embodiment of an inventive armature shaft bearing unit having alternative damping elements and alternative motion limiting elements.

### DESCRIPTION OF THE ILLUSTRATIVE EMBODIMENTS

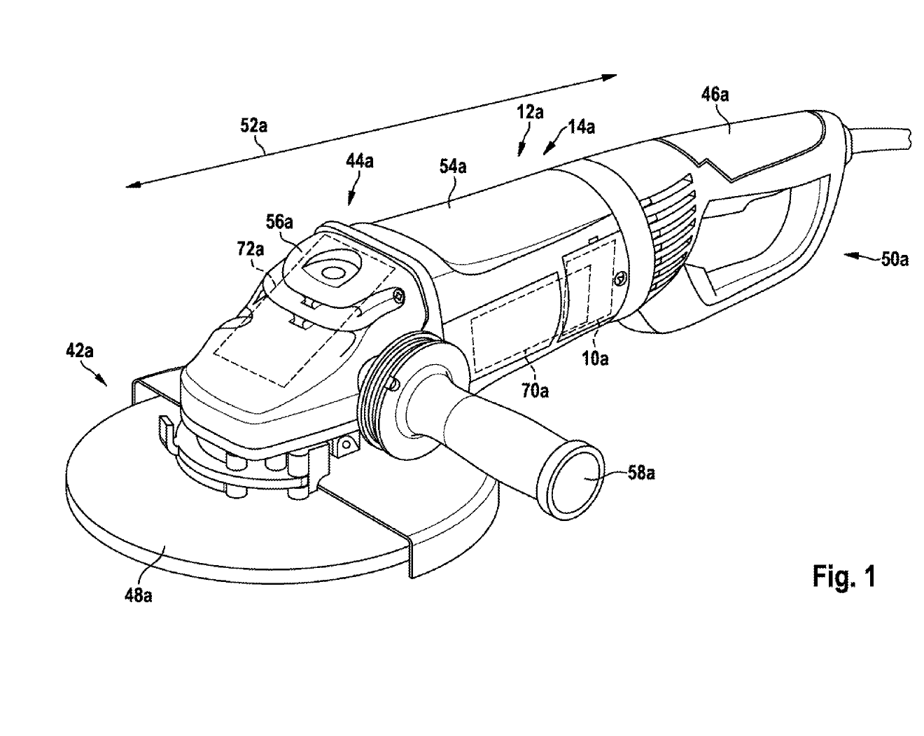

FIG. 1 shows a portable power tool 12a configured as an angle grinder 14a and having an armature shaft bearing unit 10a. The angle grinder 14a comprises a protective hood unit 42a, a housing unit 44a and a main handle 46a, which extends, on a side 50a facing away from a tool 48a, in the direction of a direction of principal extent 52a of the angle grinder 14a. The housing unit 44a comprises a motor housing 54a for receiving an electric motor 70a and a gear housing 56a for receiving a gear mechanism 72a. On the gear housing 56a is disposed an auxiliary handle 58a for the guidance of the angle grinder 14a. The auxiliary handle 58a extends transversely to the direction of principal extent 52a of the angle grinder 14a.

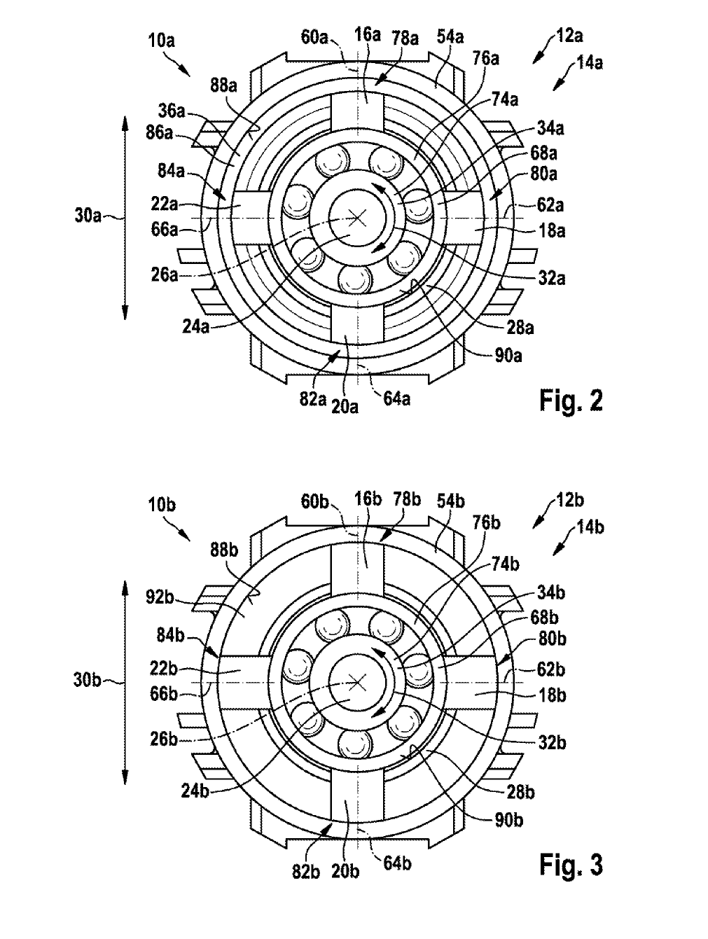

FIG. 2 shows a detailed view of a first illustrative embodiment of the armature shaft bearing unit 10a disposed in the housing unit 44a. The armature shaft bearing unit 10a is disposed in the motor housing 54a on a side of an armature shaft 24a of the electric motor 70a of the angle grinder 14a, which side is facing away from the gear mechanism 72a of the angle grinder 14a. The armature shaft bearing unit 10a further comprises four damping elements 16a, 18a, 20a, 22a, which are designed to damp vibrations of the armature shaft 24a. The four damping elements 16a, 18a, 20a, 22a are designed to damp vibrations of the armature shaft 24a, during operation of the angle grinder 14a, in a direction perpendicular to a rotational axis 26a of the armature shaft 24a. The vibrations can be induced, for instance, by small imbalances of the armature shaft 24a rotating at high speed about the rotational axis 26a and/or by masses connected in a rotationally secure manner to the armature shaft 24a, such as, for instance, of a coil, etc. (not represented here), which rotate with the armature shaft 24a about the rotational axis 26a.

The four damping elements 16a, 18a, 20a, 22a are arranged one behind the other in a peripheral direction 32a. It is also conceivable, however, that the armature shaft bearing unit 10a comprises just one damping element 16a, which extends over 360° in the peripheral direction 32a. A configuration of the armature shaft bearing unit 10a comprising two damping elements 16a, 18a which extend respectively along an angular range of 180° is likewise conceivable. The peripheral direction 32a here runs in a plane running perpendicular to the rotational axis 26a of the armature shaft 24a. The four damping elements 16a, 18a, 20a, 22a respectively have a center axis 60a, 62a, 64a, 66a. The center axes 60a, 62a, 64a, 66a are respectively arranged mutually offset by 90° along the peripheral direction 32a. The four damping elements 16a, 18a, 20a, 22a are configured as elastomer elements, which have a substantially rectangular cross section. By selecting a Shore hardness of the four damping elements 16a, 18a, 20a, 22a which is suitable for an operating condition, it is possible to adjust or predefine the damping characteristic of the four damping elements 16a, 18a, 20a, 22a. It is also conceivable, however, that the four damping elements 16a, 18a, 20a, 22a can be exchanged according to the damping requirement.

Furthermore, the armature shaft bearing unit 10a has a bearing element 34a and a bearing receiving element 36a. The bearing receiving element 36a is of disk-shaped configuration. It is also conceivable, however, that the bearing receiving element 36a is of hollow-cylindrical configuration. The bearing element 34a is configured as a roller bearing 68a and supports the armature shaft 24a on that side of the armature shaft 24a which is facing away from the gear mechanism 72a of the angle grinder 14a. The roller bearing 68a has an inner ring 74a and an outer ring 76a. The inner ring 74a of the roller bearing 68a is connected in a rotationally secure manner to the armature shaft 24a. The outer ring 76a of the roller bearing 68a is coupled to the four damping elements 16a, 18a, 20a, 22a. The four damping elements 16a, 18a, 20a, 22a are inserted in the bearing receiving element 36a and bear against the outer ring 76a of the roller bearing 68a. The bearing receiving element 36a here has receiving regions 78a, 80a, 82a, 84a for the four damping elements 16a, 18a, 20a, 22a. The four damping elements 16a, 18a, 20a, 22a are connected by means of form closure to the receiving regions 78a, 80a, 82a, 84a of the bearing receiving element 36a. The bearing receiving element 36a is configured as a bearing seat housing 86a, which is detachably connected to an inner wall 88a of the motor housing 54a.

In an alternative configuration (not represented here) of the bearing receiving element 36a, the bearing receiving element 36a is of hollow-cylindrical configuration, is mounted in the motor housing 54a such that it is displaceable along a direction running parallel to the rotational axis 26a of the armature shaft 24a, and comprises an outer periphery which is conical along the direction running parallel to the rotational axis 26a of the armature shaft 24a and which extends along the peripheral direction 32a. By moving the bearing receiving element 36a along the direction running parallel to the rotational axis 26a of the armature shaft 24a, it is hence possible to brace the four damping elements 16a, 18a, 20a, 22a disposed in the receiving regions 78a, 80a, 82a, 84a of the bearing receiving element 36a. A damping characteristic of the four damping elements 16a, 18a, 20a, 22a can thus be adjusted by an operator. An adjustment of the damping characteristic of the four damping elements 16a, 18a, 20a, 22a by means of a control unit and/or regulating unit of the angle grinder 14a, on the basis of operational parameters of the angle grinder 14a, is likewise conceivable.

The bearing receiving element 36a further has a recess 90a concentric to the armature shaft 24a and to the roller bearing 68a. The recess 90a encloses the roller bearing 68a through 360° along the peripheral direction 32a. A diameter of the roller bearing 68a is smaller than a diameter of the recess 90a, so that between the roller bearing 68a and the recess 90a is disposed a gap configured as a circular ring. Furthermore, the armature shaft bearing unit 10a has a motion limiting element 28a, which is designed to limit a motion of the armature shaft 24a in a damping direction 30a of the four damping elements 16a, 18a, 20a, 22a. The motion limiting element 28a is configured as a web and serves as a mechanical stop. Furthermore, the motion limiting element 28a is configured integrally with the bearing receiving element 36a. The motion limiting element 28a encloses the roller bearing 68a through 360° along the peripheral direction 32a and is disposed on a side of the recess 90a of the bearing receiving element 36a which is facing toward the roller bearing 68a. The motion limiting element 28a limits a maximally permitted vibration amplitude of the armature shaft 24a and of the roller bearing 68a, so that a reliable operation of the armature shaft 24a can be ensured.

During operation of the angle grinder 14a, the four damping elements 16a, 18a, 20a, 22a are compressed by vibrations of the armature shaft 24a. The compression of the four damping elements 16a, 18a, 20a, 22a is dependent on a direction of vibration of the armature shaft 24a, so that a simultaneous compression in the direction perpendicular to the rotational axis 26a of all four damping elements 16a, 18a, 20a, 22a at no point takes place. According to the vibration orientation of the armature shaft 24a, just one of the four damping elements 16a, 18a, 20a, 22a or just two of the four damping elements 16a, 18a, 20a, 22a, for instance, is/are compressed. Once the maximally permitted vibration amplitude of the armature shaft 24a is reached, the roller bearing 68a butts against the motion limiting element 28a, so that the four damping elements 16a, 18a, 20a, 22a are compressed only up to a level predetermined by the abutment of the roller bearing 68a against the motion limiting element 28a. By means of a predefined radial extent of the gap between the roller bearing 68a and the recess 90a, which gap is configured as a circular ring, a maximally permitted vibration amplitude of the armature shaft 24a and of the roller bearing 68a is predefined. The radial extent of the gap configured as a circular ring is predefined by a distance between the outer ring 76a of the roller bearing 68a and the motion limiting element 28a, or that side of the recess 90a which is facing toward the roller bearing 68a, along the direction perpendicular to the rotational axis 26a.

On a side of the armature shaft 24a which is facing toward the gear mechanism 72a of the angle grinder 14a, the angle grinder 14a comprises a further armature shaft bearing unit (not represented here), which has a structure analogous to the armature shaft bearing unit 10a. A further bearing element (not represented here), configured as a roller bearing, arranged for the support of the armature shaft 24a.

In FIGS. 3 to 14 are represented alternative illustrative embodiments. Substantially constant components, features and functions are fundamentally numbered with the same reference symbols. In order to differentiate between the illustrative embodiments, the letters a to l are added to the reference symbols of the illustrative embodiments. The following description is substantially confined to the differences relative to the first illustrative embodiment in FIGS. 1 and 2, wherein, with respect to constant components, features and functions, reference can be made to the description of the first illustrative embodiment in FIGS. 1 and 2.

FIG. 3 shows a detailed view of an armature shaft bearing unit 10b, which is disposed in a motor housing 54b of a portable power tool 12b. The portable power tool 12b has a structure analogous to the portable power tool 12a from FIG. 1. The armature shaft bearing unit 10b comprises four damping elements 16b, 18b, 20b, 22b, formed from elastomer, which are designed to damp vibrations of an armature shaft 24b in a direction perpendicular to a rotational axis 26b of the armature shaft 24b. The four damping elements 16b, 18b, 20b, 22b are arranged one behind the other along a peripheral direction 32b. Furthermore, the four damping elements 16b, 18b, 20b, 22b are arranged by means of a form closure in receiving regions 78b, 80b, 82b, 84b of the motor housing 54b. It is also conceivable, however, that the four damping elements 16b, 18b, 20b, 22b are connected integrally to the motor housing 54b by means of an injection molding process, such as, for instance, a multicomponent injection molding process. The four damping elements 16b, 18b, 20b, 22b bear against an outer ring 76b of a bearing element 34b configured as a roller bearing 68b. An inner ring 78b of the roller bearing 68b is connected in a rotationally secure manner to the armature shaft 24b.

Furthermore, the motor housing 54b comprises a circular radial continuation 92b, which extends through 360° along the peripheral direction 32b and is configured in one piece with the motor housing 54b. A motion limiting element 28b, configured as a web, of the armature shaft bearing unit 10b is configured in one piece with the radial continuation 92b. The motion limiting element 28b is configured as a mechanical stop and is designed to limit a maximally permitted vibration amplitude of the armature shaft 24b. Once the maximally permitted vibration amplitude of the armature shaft 24b is reached, the roller bearing 68b butts against the motion limiting element 28b, so that the four damping elements 16b, 18b, 20b, 22b are compressed only up to a level predetermined by the abutment of the roller bearing 68b against the motion limiting element 28b.

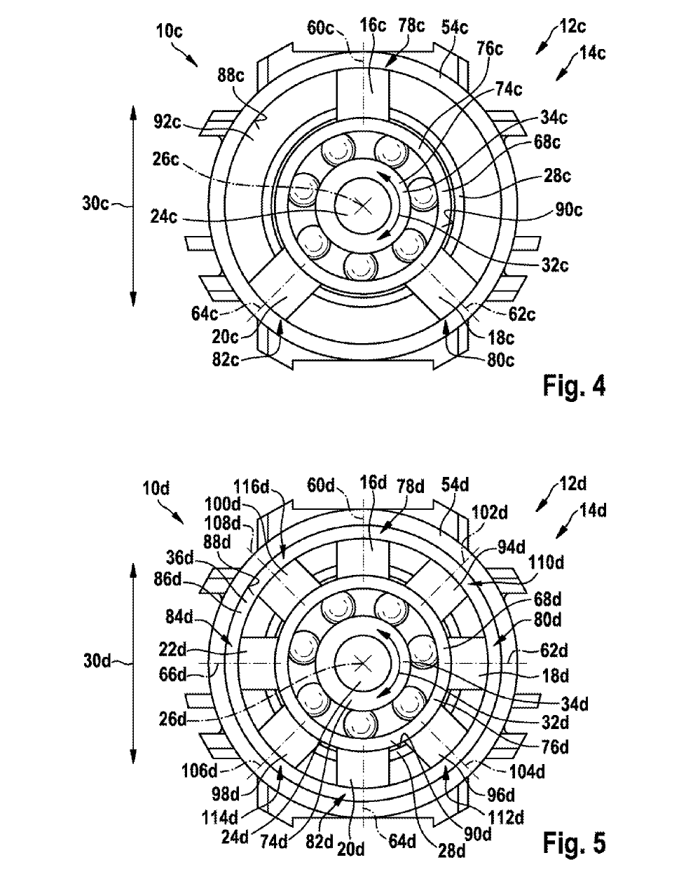

FIG. 4 shows a detailed view of an armature shaft bearing unit 10c, which is disposed in a motor housing 54c of a portable power tool 12c. The portable power tool 12c has a structure analogous to the portable power tool 12a from FIG. 1. The armature shaft bearing unit 10c comprises three damping elements 16c, 18c, 20c, formed from elastomer, which are designed to damp vibrations of an armature shaft 24c in a direction perpendicular to a rotational axis 26c of the armature shaft 24c. The motor housing 54c further comprises a circular-ring-shaped radial continuation 92c, which extends through 360° along the peripheral direction 32c and is configured in one piece with the motor housing 54c. A motion limiting element 28c, configured as a web, of the armature shaft bearing unit 10c is configured in one piece with the radial continuation 92c and encloses a bearing element 34c, configured as a roller bearing 68c, of the armature shaft bearing unit 10c through 360° along the peripheral direction 32c. The three damping elements 16c, 18c, 20c are arranged one behind the other in a peripheral direction 32c. Furthermore, the three damping elements 16c, 18c, 20c respectively have a center axis 60c, 62c, 64c. The center axis 60c of a first damping element 16c of the three damping elements 16c, 18c, 20c forms together with a center axis 62c of a second damping element 18c of the three damping elements 16c, 18c, 20c an angle of about 135°. The center axis 62c of the second damping element 20c forms together with the center axis 64c of a third damping element 20c of the three damping elements 16c, 18c, 20c an angle of about 90°. The center axis of the third damping element 20c forms together with the center axis 60c of the first damping element 16c an angle of about 135°. A bearing receiving element 34c of the armature shaft bearing unit 10c is configured in one piece with the motor housing 54c. The three damping elements 16c, 18c, 20c are arranged by form closure in receiving regions 78c, 80c, 82c of the motor housing 54c. The receiving regions 78c, 80c, 82c are configured in one piece with the motor housing 54c. A bearing receiving element 34c of the armature shaft bearing unit 10c is likewise configured in one piece with the motor housing 54c.

FIG. 5 shows a detailed view of an armature shaft bearing unit 10d, which is disposed in a motor housing 54d of a portable power tool 12d. The portable power tool 12d has a structure analogous to the portable power tool 12a from FIG. 1. The armature shaft bearing unit 10d comprises eight damping elements 16d, 18d, 20d, 22d, 94d, 96d, 98d, 100d, formed from elastomer, which are designed to damp vibrations of an armature shaft 24d in a direction perpendicular to a rotational axis 26d of the armature shaft 24d. The eight damping elements 16d, 18d, 20d, 22d, 94d, 96d, 98d, 100d are arranged one behind the other in a peripheral direction 32d and respectively comprise a center axis 60d, 62d, 64d, 66d, 102d, 104d, 106d, 108d, which are respectively arranged mutually offset by 45° along the peripheral direction 32d. Furthermore, the armature shaft bearing unit 10d comprises a bearing receiving element 36d, in which the eight damping elements 16d, 18d, 20d, 22d, 94d, 96d, 98d, 100d are arranged by means of a form closure in receiving regions 78d, 80d, 82d, 84d, 110d, 112d, 114d, 116d of the bearing receiving element 36d. It is also conceivable, however, that the eight damping elements 16d, 18d, 20d, 22d, 94d, 96d, 98d, 100d are respectively arranged by means of another type of connection which appears sensible to a person skilled in the art, such as, for instance, material bonding or force closure, in the respective receiving region 78d, 80d, 82d, 84d, 110d, 112d, 114d, 116d of the bearing receiving element 36d.

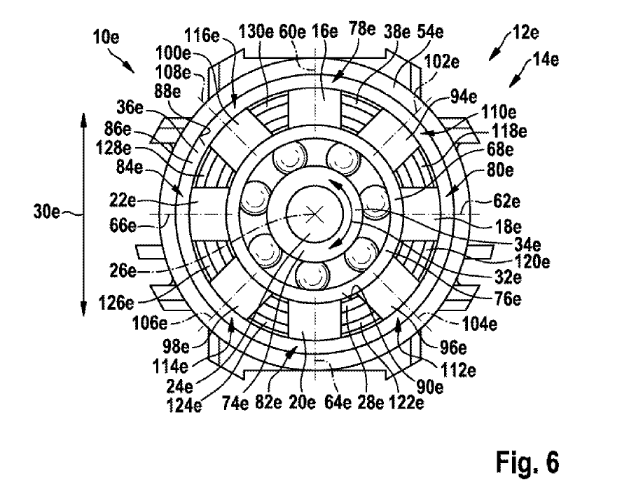

FIG. 6 shows a detailed view of an armature shaft bearing unit 10e, which is disposed in a motor housing 54e of a portable power tool 12e. The portable power tool 12e has a structure analogous to the portable power tool 12a from FIG. 1. The armature shaft bearing unit 10e comprises at least two damping elements 16e, 18e, formed from elastomer, and at least one connecting element 38e, which fixedly connects two damping elements 16e, 18e to form an assembly unit, which is designed for fitting in the portable power tool 12e configured as an angle grinder 14e. In particular, the armature shaft bearing unit 10e has eight damping elements 16e, 18e, 20e, 22e, 94e, 96e, 98e, 100e and eight connecting elements 38e, 118e, 120e, 122e, 124e, 126e, 128e, 130e. The eight damping elements 38e, 118e, 120e, 122e, 124e, 126e, 128e, 130e are arranged one behind the other in a peripheral direction 32e and respectively comprise a center axis 60e, 62e, 64e, 66e, 102e, 104e, 106e, 108e, which are respectively arranged mutually offset by 45° along the peripheral direction 32e. A number of the connecting elements 38e, 118e, 120e, 122e, 124e, 126e, 128e, 130e is dependent on a number of the damping elements 16e, 18e, 20e, 22e, 94e, 96e, 98e, 100e. It is also conceivable, however, that just one connecting element 38e configured as a ring connects the damping elements 16e, 18e, 20e, 22e, 94e, 96e, 98e, 100e one to another. The connecting elements 38e, 118e, 120e, 122e, 124e, 126e, 128e, 130e respectively connect two sides of the eight damping elements 16e, 18e, 20e, 22e, 94e, 96e, 98e, 100e integrally to one another, which sides are mutually facing along the peripheral direction 32e. It is also conceivable, however, that the connecting elements connect the sides to one another by means of another type of connection which appears sensible to a person skilled in the art. By connecting the eight damping elements 16e, 18e, 20e, 22e, 94e, 96e, 98e, 100e by the eight connecting elements 38e, 118e, 120e, 122e, 124e, 126e, 128e, 130e, it is possible to ensure that the eight damping elements 16e, 18e, 20e, 22e, 94e, 96e, 98e, 100e respectively substantially maintain a position relative to one another. A simple assembly of the eight damping elements 16e, 18e, 20e, 22e, 94e, 96e, 98e, 100e can thus be achieved.

Furthermore, the armature shaft bearing unit 10e comprises a bearing receiving element 36e, in which the eight damping elements 16e, 18e, 20e, 22e, 94e, 96e, 98e, 100e are respectively arranged by means of form closure in receiving regions 78e, 80e, 82e, 84e, 110e, 112e, 114e, 116e of the bearing receiving element 36e. It is also conceivable, however, that the eight damping elements 16e, 18e, 20e, 22e, 94e, 96e, 98e, 100e are respectively arranged by means of another type of connection which appears sensible to a person skilled in the art, such as for example material bonding or force closure, in the respective receiving region 78e, 80e, 82e, 84e, 110e, 112e, 114e, 116e of the bearing receiving element 36e.

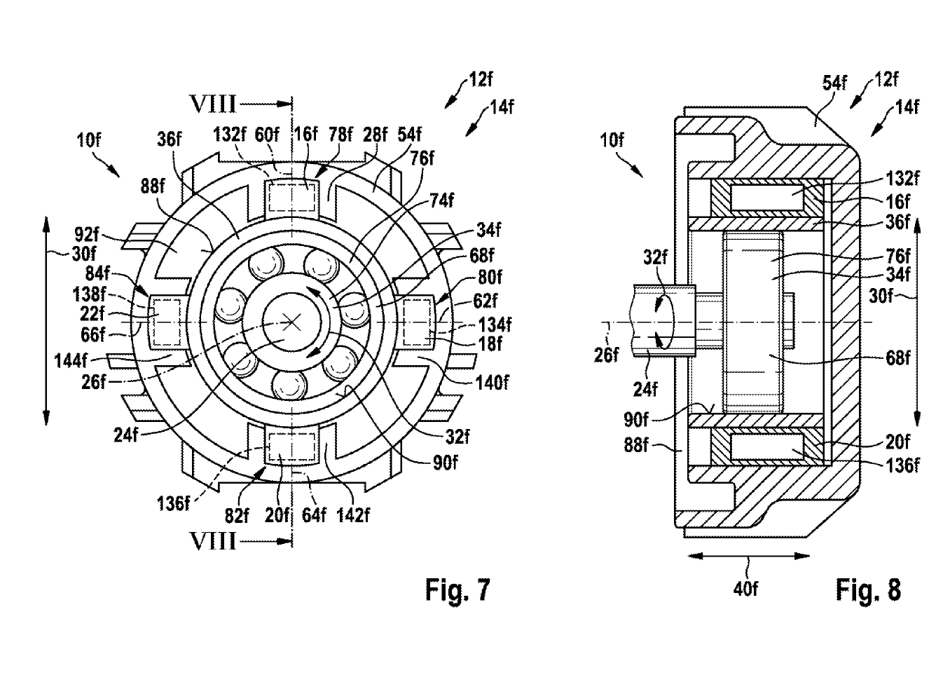

FIG. 7 shows a detailed view of an armature shaft bearing unit 10f, which is disposed in a motor housing 54f of a portable power tool 12f. The portable power tool 12f has a structure analogous to the portable power tool 12a from FIG. 1. The armature shaft bearing unit 10f comprises four damping elements 16f, 18f, 20f, 22f, formed from elastomer, which are arranged one behind the other along a peripheral direction 32f and which are designed to damp vibrations of an armature shaft 24f in a direction perpendicular to a rotational axis 26f of the armature shaft 24f. The four damping elements 16f, 18f, 20f, 22f are arranged in pocket-like receiving regions 78f, 80f, 82f, 84f of the motor housing 54f by means of a form closure. Furthermore, the four damping elements 16f, 18f, 20f, 22f respectively have an interior space 132f, 134f, 136f, 138f filled with a vibration-damping medium, such as, for instance, a gas. The four damping elements 16f, 18f, 20f, 22f are thus configured as so-called damper cushions (FIG. 8).

The armature shaft bearing unit 10f has motion limiting elements 28f, 140f, 142f, 144f, which are configured in one piece with the receiving regions 78f, 80f, 82f, 84f of the motor housing 54f. The armature shaft bearing unit 10f further comprises a bearing element 34f configured as a roller bearing 68f and a hollow-cylindrical bearing receiving element 36f, which is arranged in a damping direction 30f between the bearing element 34f and the damping elements 16f, 18f, 20f, 22f. The damping direction 30f runs perpendicular to the rotational axis 26f of the armature shaft 24f. The bearing receiving element 36f bears with a side facing toward the roller bearing 68f against an outer ring 76f of the roller bearing 68f. On a side 146f of the bearing receiving element 36f which is facing toward an inner wall 88f of the motor housing 54f, the bearing receiving element 36f bears against the four damping elements 16f, 18f, 20f, 22f, so that the bearing receiving element 36f is framed along the peripheral direction 32f by the four damping elements 16f, 18f, 20f, 22f. The motion limiting elements 28f, 140f, 142f, 144f extend perpendicular to the rotational axis 26f in the direction of that side 146f of the bearing receiving element 36f which is facing toward the motor housing 54f. Between that side 146f of the bearing receiving element 36f which is facing toward the motor housing 54f and the motion limiting elements 28f, 140f, 142f, 144f, a small distance is predefined by the one maximally permitted vibration amplitude of the armature shaft 24f.

During operation of the portable power tool 14f, the four damping elements 16f, 18f, 20f, 22f are compressed, in dependence on a vibration orientation, by vibrations of the armature shaft 24f, and the vibration-damping medium disposed in the interior spaces 132f, 134f, 136f, 138f of the four damping elements 16f, 18f, 20f, 22f is compressed, so that a damping of the vibrations of the armature shaft 24f is effected. Once the maximally permitted vibration amplitude of the armature shaft 24f is reached, the bearing receiving element 36f bears against at least one of the motion limiting elements 28f, 140f, 142f, 144f, so that the four damping elements 16f, 18f, 20f, 22f, and thus the vibration-damping medium disposed in the interior spaces 132f, 134f, 136f 138f of the four damping elements 16f, 18f, 20f, 22f, are compressed only up to a level predetermined by the abutment of the bearing receiving element 34f against one of the motion limiting elements 28f, 140f, 142f, 144f.

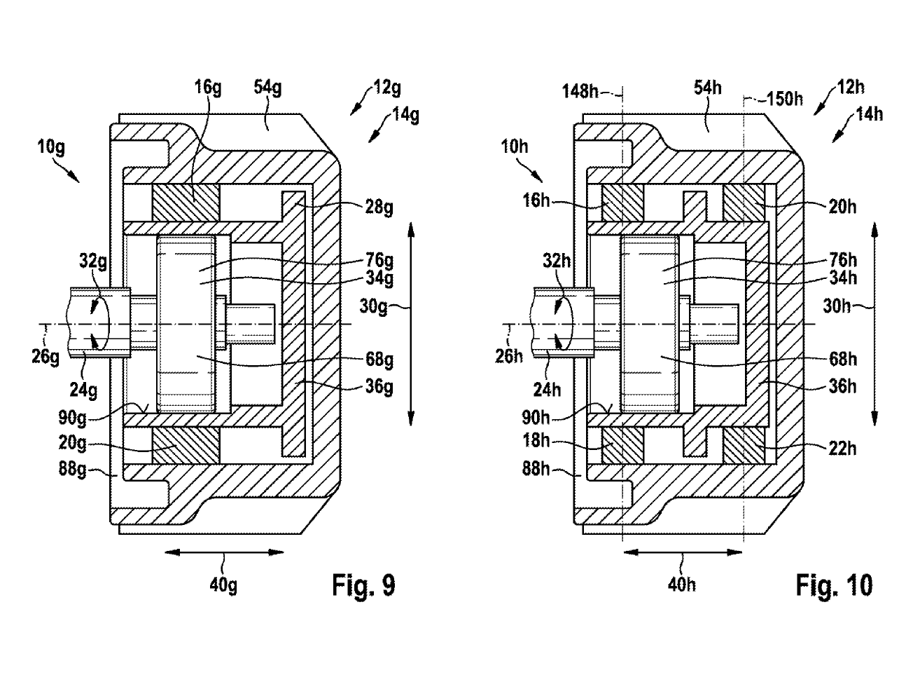

FIG. 9 shows a sectional view of an armature shaft bearing unit 10g, which is disposed in a motor housing 54g of a portable power tool 12g. The portable power tool 12g has a structure analogous to the portable power tool 12a from FIG. 1. The armature shaft bearing unit 10g comprises four damping elements 16g, 18g, 20g, 22g (only two represented), formed from elastomer, which are arranged one behind the other along a peripheral direction 32g and which are designed to damp vibrations of an armature shaft 24g in a direction perpendicular to a rotational axis 26g of the armature shaft 24g. The four damping elements 16g, 18g, 20g, 22g have a rectangular cross section. Furthermore, the armature shaft bearing unit 10g comprises a bearing element 34g, configured as a roller bearing 68g, and a pot-like bearing receiving element 36g, which is disposed in a damping direction 30g between the roller bearing 68g and the four damping elements 16g, 18g, 20g, 22g. The damping direction 30g runs perpendicular to the rotational axis 26g of the armature shaft 24g. The four damping elements 16g, 18g, 20g, 22g are here configured integrally with the bearing receiving element 36g.

The armature shaft bearing unit 10g further comprises a motion limiting element 28g configured as a collar, which is configured integrally with the bearing receiving element 36g. The motion limiting element 28g configured as a collar is arranged offset to the four damping elements 16g, 18g, 20g, 22g along an axial direction 40g. Furthermore, the motion limiting element 28g configured as a collar extends through 360° along the peripheral direction 32g. It is also conceivable, however, that the motion limiting element 28g extends segmentally along the peripheral direction. In a direction perpendicular to the rotational axis 26g, the motion limiting element 28g configured as a collar is arranged at a distance from an inner wall 88g of the motor housing 54g. A maximally permitted vibration amplitude of the armature shaft 24g is hereby predefined.

During operation of the portable power tool 14g, the four damping elements 16g, 18g, 20g, 22g are compressed, in dependence on a vibration orientation, by vibrations of the armature shaft 24g, so that a damping of the vibrations of the armature shaft 24g is effected. Once the maximally permitted vibration amplitude of the armature shaft 24g is reached, the motion limiting element 28g configured integrally with the bearing receiving element 36g butts against the inner wall 88g of the motor housing 54g. The four damping elements 16g, 18g, 20g, 22g are compressed, according to vibration orientation, only up to a level predetermined by the abutment of the motion limiting element 28g against the inner wall 88g of the motor housing 54g.

FIG. 10 shows a sectional view of an armature shaft bearing unit 10h, which is disposed in a motor housing 54h of a portable power tool 12h. The portable power tool 12h has a structure analogous to the portable power tool 12a from FIG. 1. The armature shaft bearing unit 10h comprises eight damping elements 16h, 18h, 20h, 22h, formed from elastomer, of which four are represented, a bearing element 34h configured as a roller bearing 68h, and a bearing receiving element 36h. The damping elements 16h, 18h, 20h, 22h are arranged one behind the other along a peripheral direction 32h and are designed to damp vibrations of an armature shaft 24h in a direction perpendicular to a rotational axis 26h of the armature shaft 24h. In each case four damping elements 16h, 18h (only two represented) are arranged along an axial direction 40h at a distance from the remaining four damping elements 20h, 22h (only two represented). Thus four damping elements 16h, 18h (only two represented) are disposed in a first damping plane 148h and four damping elements 20h, 22h (only two represented) are disposed in a second damping plane 150h. The first damping plane 148h is arranged such that it is distanced from the second damping plane 150h along the axial direction 40h by at least one bearing element width.

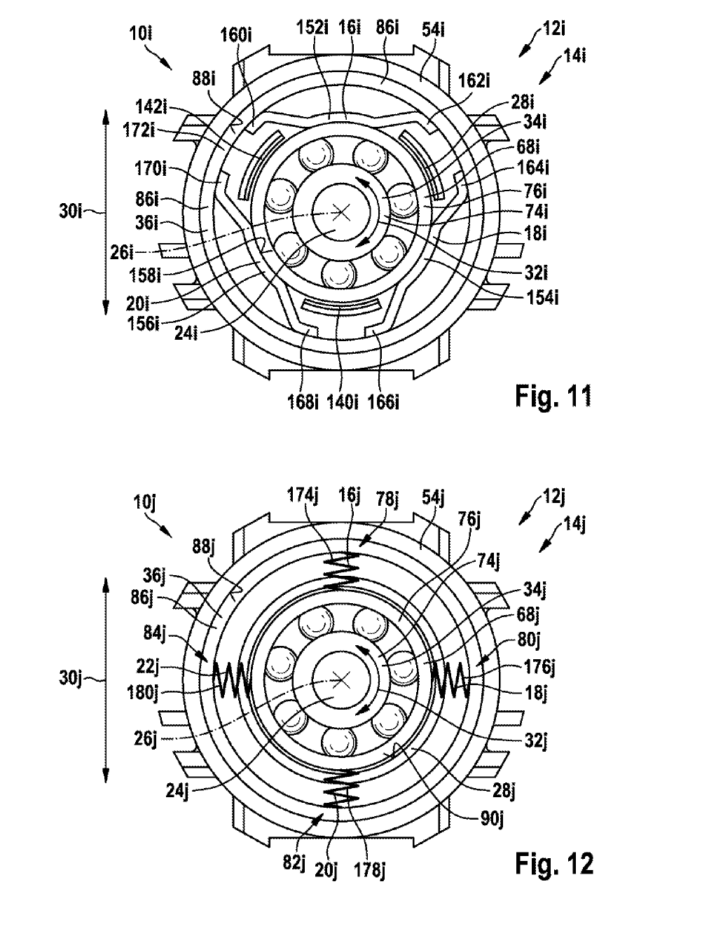

The armature shaft bearing unit 10h further comprises a motion limiting element 28h configured as a collar, which is configured integrally with the bearing receiving element 36h. The motion limiting element 28h configured as a collar is disposed along the axial direction 40h spatially between the first damping plane 148h and the second damping plane 150h. The motion limiting element 28h configured as a collar also extends through 360° along the peripheral direction 32h. It is also conceivable, however, that the motion limiting element 28h extends segmentally along the peripheral direction. In a direction perpendicular to the rotational axis 26h, the motion limiting element 28h configured as a collar is arranged at a distance from an inner wall 88h of the motor housing 54h. A maximally permitted vibration amplitude of the armature shaft 24h is hereby predefined. FIG. 11 shows a detailed view of an armature shaft bearing unit 10i, which is disposed in a motor housing 54i of a portable power tool 12i. The portable power tool 12i has a structure analogous to the portable power tool 12a from FIG. 1. The armature shaft bearing unit 10i comprises three damping elements 16i, 18i, 20i, configured as leaf springs 152i, 154i, 156i, a bearing element 34i, configured as a roller bearing 68i, and a bearing receiving element 36i. The three damping elements 16i, 18i, 20i are arranged one behind the other along a peripheral direction 32i and are designed to damp vibrations of an armature shaft 24i in a direction perpendicular to a rotational axis 26i of the armature shaft 24i. The three damping elements 16i, 18i, 20i, configured as leaf springs 152i, 154i, 156i, are molded to the bearing receiving element 36i. It is also conceivable, however, to connect the damping elements 16i, 18i, 20i to the bearing receiving element 36i by means of another type of connection which appears sensible to a person skilled in the art. Furthermore, the three damping elements 16i, 18i, 20i, configured as leaf springs 152i, 154i, 156i, bear with one side 158i tangentially against the roller bearing 68i and respectively with two legs 160i, 162i, 164i, 166i, 168i, 170i against a collar 172i of the bearing receiving element 36i and thus brace the roller bearing 68i. The armature shaft 24i, rotatably supported by means of the roller bearing 68i, can vibrate, in dependence on a linear or progressive characteristic curve of the damping elements 16i, 18i, 20i configured as leaf springs 152i, 154i, 156i, up to a maximally permitted vibration amplitude.

The armature shaft bearing unit 10i further comprises three motion limiting elements 28i, 140i, 142i, configured as webs, which are configured integrally with the bearing receiving element 36i. The motion limiting elements 28i, 140i, 142i extend along the peripheral direction 32i respectively over an angular range of about 45°. In a direction perpendicular to the rotational axis 26i, the motion limiting elements 28i, 140i, 142i are arranged at a distance from an outer ring 76i of the roller bearing 68i. A maximally permitted vibration amplitude of the armature shaft 24i is hereby predefined.

FIG. 12 shows a detailed view of an armature shaft bearing unit 10j, which is disposed in a motor housing 54j of a portable power tool 12j. The portable power tool 12j has a structure analogous to the portable power tool 12a from FIG. 1. The armature shaft bearing unit 10j comprises four damping elements 16j, 18j, 20j, 22j, configured as helical springs 174j, 176j, 178j, 180j, a bearing element 34j, configured as a roller bearing 68j, and a bearing receiving element 36j. The four damping elements 16j, 18j, 20j, 22j are arranged one behind the other along a peripheral direction 32j and are designed to damp vibrations of an armature shaft 24j in a direction perpendicular to a rotational axis 26j of the armature shaft 24j. A limitation of a maximally permitted vibration amplitude of the armature shaft 24j and an arrangement of the four damping elements 16j, 18j, 20j, 22j within the bearing receiving element 36j is realized analogously to the description of the first illustrative embodiment in FIG. 2.

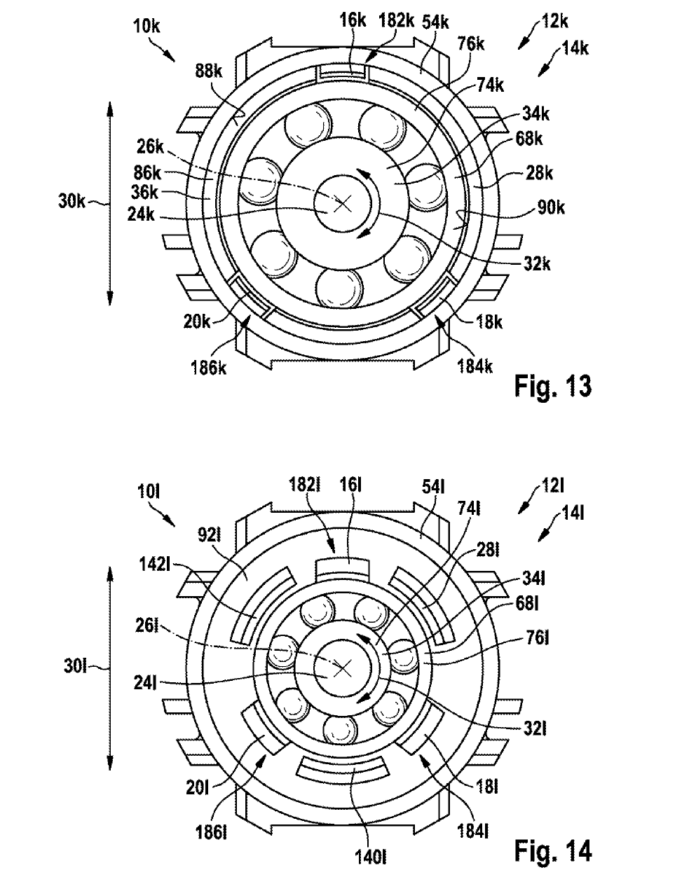

FIG. 13 shows a detailed view of an armature shaft bearing unit 10k, which is disposed in a motor housing 54k of a portable power tool 12k. The portable power tool 12k has a structure analogous to the portable power tool 12a from FIG. 1. The armature shaft bearing unit 10k comprises a bearing element 34k, configured as a roller bearing 68k, a bearing receiving element 36k, and three damping elements 16k, 18k, 20k configured integrally with the bearing receiving element 36k. The damping elements 16k, 18k, 20k have as a result of their resiliently elastic design, in a respective transitional region 182k, 184k, 186k from the three damping elements 16k, 18k, 20k into the bearing receiving element 36k, a damping effect, so that the three damping elements 16k, 18k, 20k locally brace the roller bearing 68k. The resiliently elastic design is achieved, for instance, by a smaller material thickness of the transitional regions 182k, 184k, 186k compared to a side of the damping elements 16k, 18k, 20k which bears against an outer ring 76k. A limitation of a maximally permitted vibration amplitude of the armature shaft 24k is realized substantially analogously to the description of the first illustrative embodiment in FIG. 2, wherein an arrangement of the three damping elements 16k, 18k, 20k along a peripheral direction 32k is analogous to the description of FIG. 4.

FIG. 14 shows a detailed view of an armature shaft bearing unit 10l, which is disposed in a motor housing 54l of a portable power tool 12l. The portable power tool 12l has a structure analogous to the portable power tool 12a from FIG. 1. The armature shaft bearing unit 10l comprises a bearing element 34l, configured as a roller bearing 68l, three motion limiting elements 28l, 140l, 142l, and three damping elements 16l, 18l, 20l. The roller bearing 68l is disposed directly in a bearing seat of the motor housing 54l. The three motion limiting elements 28l, 140l, 142l, the three damping elements 16l, 18l, 20l and the motor housing 54l are here configured in one piece. A limitation of a maximally permitted vibration amplitude of the armature shaft 24l is realized substantially analogously to the description of the first illustrative embodiment in FIG. 2, wherein an arrangement of the three damping elements 16l, 18l, 20l along a peripheral direction 32l is analogous to the description of FIG. 4.

1. An armature shaft bearing unit for a portable power tool, comprising:
at least one damping element configured to damp vibrations of an armature shaft, and
at least one motion limiting element configured to limit a motion of the armature shaft in at least one damping direction of the at least one damping element.

2. The armature shaft bearing unit as claimed in claim 1, wherein the at least one damping element is at least substantially configured to damp vibrations of the armature shaft during operation in a direction at least substantially perpendicular to a rotational axis of the armature shaft.

3. The armature shaft bearing unit as claimed in claim 1, further comprising at least two damping elements arranged one behind the other in a peripheral direction.

4. The armature shaft bearing unit as claimed in claim 1, further comprising at least one bearing element and at least one bearing receiving element h), the bearing receiving element being disposed in at least one damping direction between the bearing element and the at least one damping element.

5. The armature shaft bearing unit as claimed in claim 4, wherein the at least one motion limiting element is configured integrally with the bearing receiving element.

6. The armature shaft bearing unit as claimed in claim 4, wherein the bearing receiving element is configured integrally with the at least one damping element.

7. The armature shaft bearing unit as claimed in claim 1, further comprising at least two damping elements and at least one connecting element, the connecting element fixedly connecting the two damping elements to form an assembly unit configured to be fitted into a portable power tool.

8. The armature shaft bearing unit as claimed in claim 1, further comprising at least two damping elements spaced apart in the axial direction.

9. A portable power tool, comprising:
an armature shaft bearing unit including:
at least one damping element configured to damp vibrations of an armature shaft, and
at least one motion limiting element configured to limit a motion of the armature shaft in at least one damping direction of the at least one damping element.

10. The armature shaft bearing unit as claimed in claim 1, wherein the portable power tool is an angle grinder.

11. The portable power tool as claimed in claim 9, wherein the portable power tool is an angle grinder.
